(19) United States
(12) Patent Application Publication
(10) Pub. No.: US 2013/0066583 A1
(43) Pub. Date: Mar. 14, 2013

(54) ESTIMATION OF THE TEMPERATURE OUTSIDE A VEHICLE FROM TEMPERATURE MEASUREMENTS UNDER THE BONNET OF A VEHICLE

(71) Applicants: Francois Foussard, Versailles (FR); Stephane Guegan, Versailles (FR); Nicolas Romani, Paris (FR); Philippe Saint Loup, Jouars Pontchartrain (FR)

(72) Inventors: Francois Foussard, Versailles (FR); Stephane Guegan, Versailles (FR); Nicolas Romani, Paris (FR); Philippe Saint Loup, Jouars Pontchartrain (FR)

(73) Assignee: RENAULT s.a.s., Boulogne-Billancourt (FR)

(21) Appl. No.: 13/639,972

(22) PCT Filed: Apr. 7, 2011
(86) PCT No.: PCT/FR11/50791

§ 371 Date: Nov. 20, 2012

(30) Foreign Application Priority Data
Apr. 8, 2010 (FR) 1052664

(51) Int. Cl. G01K 13/00; G06F 15/00

(52) U.S. Cl. 702/130

(57) ABSTRACT

A method for determining an estimated value of air temperature outside a vehicle driven by an internal combustion engine, according to which an initial estimated value is attributed to an estimated temperature, the temperature of an intake air of the engine is then measured, and a speed of the vehicle is assessed, followed by a mathematical filtering of the measured temperature of the intake air of the engine. The filtering operation imposes a maximum gradient on the estimated temperature, that has at least two separate positive values over time, either one of the maximum positive gradient values being selected according to the momentary speed of the vehicle.

The invention relates to the field of temperature monitoring of the mechanical components of a vehicle powered by an internal combustion engine. In order to estimate the temperature of these components, generally speaking, the heat energy dissipated by friction within these components and the heat energy evacuated by contact with the air surrounding the component, in other words the air located under the engine hood or the air outside the vehicle, is calculated. In the case of a four wheel drive vehicle, it thus involves calculating the temperature of a coupler, transmitting the engine torque available on one wheel set toward the other wheel set of the vehicle. In this case in particular, the temperature outside the vehicle is a data value indispensable for calculating in a reliable manner the heating of the coupler.

For reasons of reduction in manufacturing costs and in costs of maintenance of the vehicle, the number of temperature sensors installed on the vehicle is limited to the strict minimum needed. It is thus desirable to have monitoring methods obviating the need for a sensor on the component (for example on the coupler) to be monitored, but also obviating the need for a temperature sensor outside the vehicle, especially given that such an external temperature sensor is necessarily subjected to external stresses which limit its precision.

The patent application EP 1 308 336 describes a method for management of a coupler depending on its heating, together with a method for calculating the heating as a function, amongst other parameters, of the temperature outside the vehicle.

The patent application US 2004/0 184 509 includes the calculation of the temperature of the air outside the vehicle based on the air temperature measured in an air inlet pipe to the engine. When the vehicle starts up, the system resets the temperature either to the last temperature stored, or to the temperature measured at the inlet at the time of the starting, by choosing the lowest of these two values. The system then monitors the probability that a stabilized engine speed is established by notably monitoring the driving time of the vehicle, the instantaneous speed of the vehicle, and the flow of air admitted into the engine. If the instantaneous speed is less than a certain threshold, or the flow of air admitted is less than another threshold, an incremental value of overheating is arbitrarily added to the value of incoming air temperature with respect to the value of outside air temperature. The temperature of the air admitted into the engine is taken as a valid estimation of the outside air temperature when the calculated value of overheating is small enough. This method has the drawback of underestimating the outside air temperature, therefore that of the components cooled by this outside air. Furthermore, it requires the existence of a flow sensor on the air inlet circuit in the engine.

The patent application US 2005/007 1074 includes the estimation of the outside air temperature based on a temperature measured at the inlet of a turbocompressor, by correcting this inlet temperature of the turbocompressor as a function of the operating parameters, hence of the potential for heating of the engine compartment, and by also correcting it as a function of the activation or of the inactivation of a cooling fan in the engine compartment. The document does not specify how the initial value of outside temperature is determined when the temperature estimation commences. The method provided requires correction algorithms or nomographs for the temperature, as a function of the speed of the engine and of the state of activity of the fan, and requires calculation means that are fast enough to handle these algorithms or these nomographs. Furthermore, these algorithms and these nomographs will be specific to a given model of vehicle.

The aim of the invention is to provide a method for estimating the air temperature outside a vehicle, allowing an estimated value of temperature to be available as soon as the vehicle is started. The method must be sufficiently precise while the vehicle is being driven, and sufficiently secured when it is started in order to avoid a risk of overheating of a component following a hot start of the vehicle.

In one method for determining an estimated value of air temperature outside a vehicle propelled by an internal combustion engine, an initial estimated value is assigned to the estimated temperature, then the temperature of the air admitted into the engine is measured and the speed of the vehicle is evaluated. A mathematical filtering of the measured temperature of the air admitted into the engine is carried out, the filtering imposing on the temperature a maximum gradient taking at least two different positive values over time, one or the other of these values of maximum positive gradient being selected depending on the instantaneous speed of the vehicle.

According to one preferred embodiment, an initial temperature of the air admitted into the engine and an initial temperature of the coolant liquid having spent time in the cooling circuit of the engine are measured, and an initial estimated value of temperature is deduced from these two values.

Advantageously, a first maximum temperature threshold is imposed on the estimated air temperature and on its initial value.

The value of the first maximum temperature threshold may be imposed on the initial estimated value of temperature, in particular if the difference between the initial temperature of the air admitted into the engine and the initial temperature of the coolant liquid is higher than a second difference threshold.

The first maximum temperature threshold may also be imposed on the initial estimated value if the initial temperature of incoming air is higher than a third threshold, or if the initial temperature of the coolant liquid is higher than a fourth threshold.

According to one preferred embodiment, the initial temperature of the air admitted into the engine is taken as initial estimated value, or the initial temperature of the coolant liquid when the difference between these two temperatures is less than the second difference threshold.

Advantageously, the estimated temperature is equal to the temperature of the air admitted into the engine over the periods of time where the temperature of the air admitted into the engine is decreasing.

At least two different maximum positive gradients may be imposed on the estimated temperature when the latter is increasing, and at least one minimum negative gradient when the estimated temperature is decreasing, the negative gradient being higher, in absolute value, than at least ten times each of the two positive gradients.

According to one preferred embodiment, the filtering imposes a first maximum positive gradient in the range between 0.001° C./s and 0.01° C./s, and a second maximum positive gradient which is a multiple of the first positive gradient by a number in the range between 2 and 5.

The method may be applied to a coupler for transferring a torque between two sets of wheels of a vehicle, using a method for estimating the air temperature outside the vehicle such as previously described.

According to another aspect, a system for determining an estimated value of air temperature outside a vehicle propelled by an internal combustion engine comprises a sensor for the temperature of the air admitted into the engine, a sensor for the temperature of the coolant liquid in the engine, a device for evaluating the instantaneous speed of the vehicle, a reset module capable of determining an initial temperature based on an initial temperature of the air admitted into the engine and on an initial temperature of the coolant liquid. The system also comprises an estimation module designed to mathematically filter the temperature of the air admitted into the engine, in such a manner as to impose on the filtered value a maximum gradient taking at least two different positive values over time, one or the other of these values of maximum positive gradient being selected depending on the instantaneous speed of the vehicle.

Other aims, advantages and features of the invention will become apparent upon examining the detailed description of some embodiments presented by way of non-limiting examples, and illustrated by the appended drawings, in which:

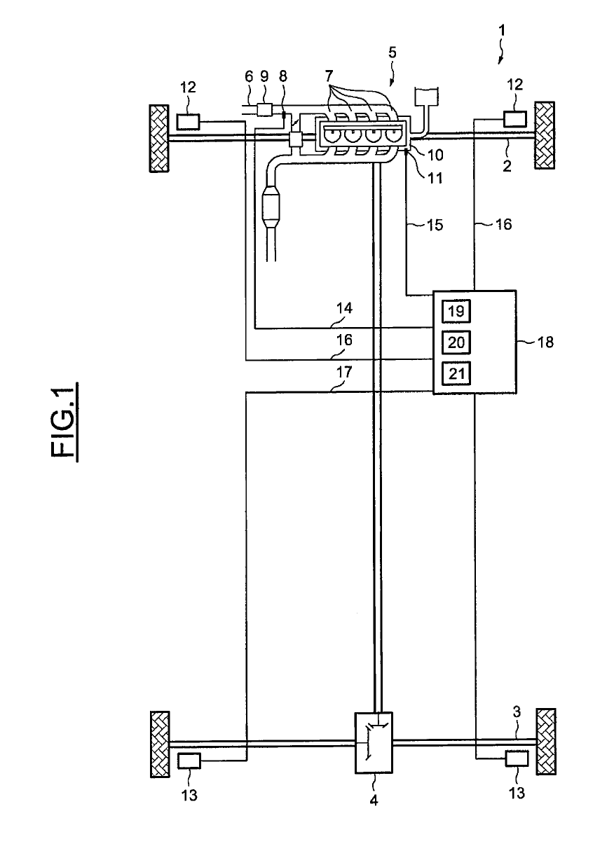

FIG. 1 illustrates a four wheel drive vehicle equipped with a system for estimating the outside temperature according to the invention;

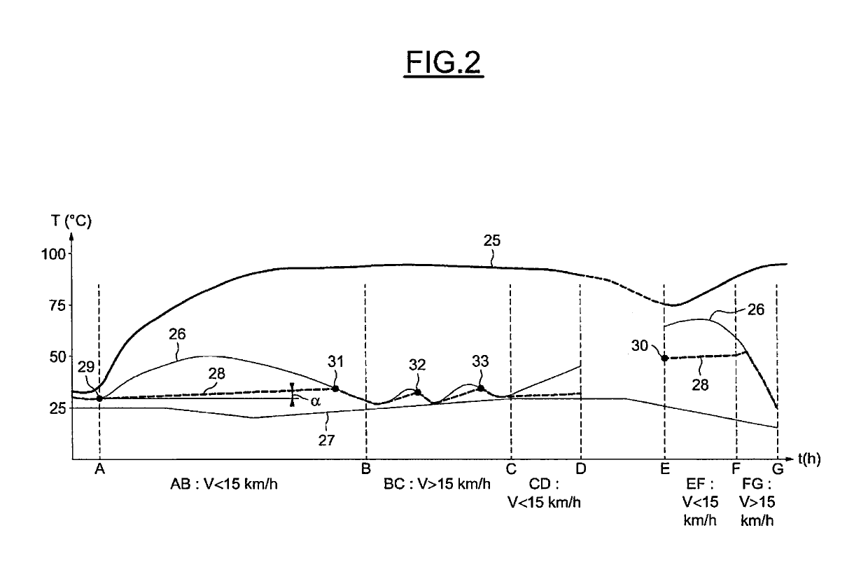

FIG. 2 illustrates one example of variation of temperature of the coolant liquid, of temperature of the air admitted into the engine, and of estimated temperature of the outside air, recorded or calculated on the vehicle in FIG. 1;

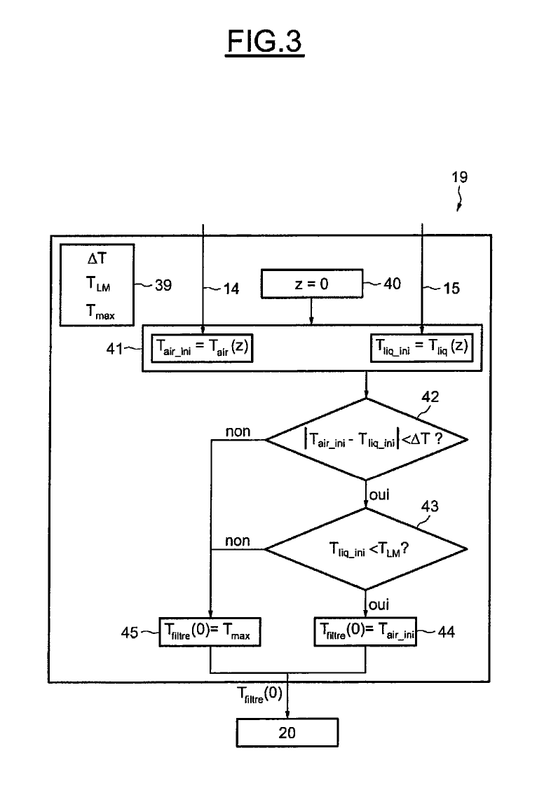

FIG. 3 illustrates the operation of a reset module belonging to a system for estimating the temperature according to the invention;

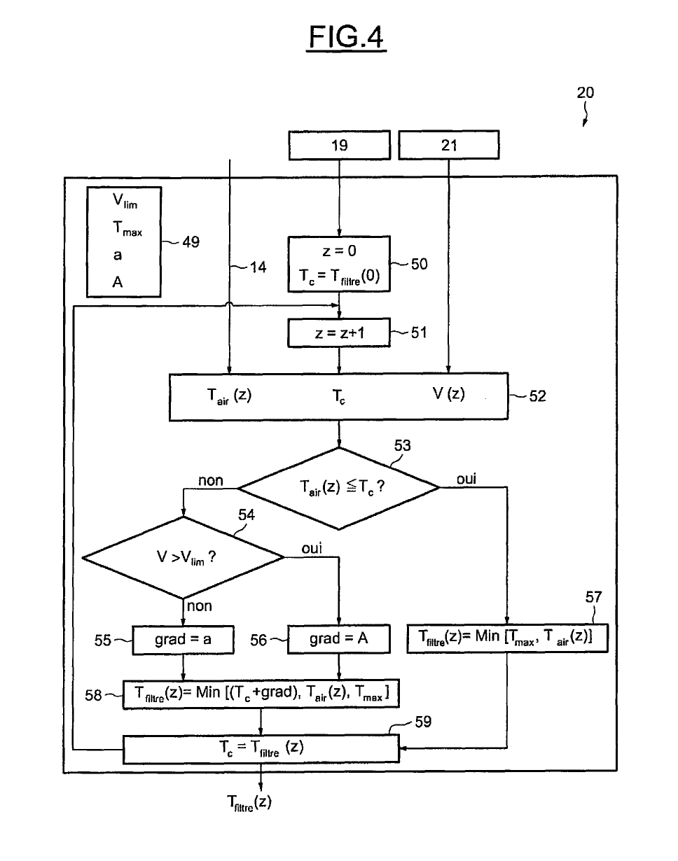

FIG. 4 illustrates the operation of a current calculation module for the temperature outside the vehicle belonging to a system for estimating the temperature according to the invention.

Such as illustrated in FIG. 1, a vehicle 1 comprises a front wheel set 2 and a rear wheel set 3, the front set 2 and the rear set 3 being connected via a coupler 4 designed to totally or partially lock in rotation the axis of the front set 2 and the axis of the rear set 3. Each of the wheels of the front set 2 is fitted with a rotational speed sensor 12 and each of the wheels of the rear set 3 is equipped with a rotational speed sensor 13. The values recorded by the sensors 12 and 13 notably allow the difference in rotation speed between the axis of the front set 2 and the axis of the rear set 3 to be calculated, together with the instantaneous speed of the vehicle 1. Such sensors are generally present on the four wheels of a four wheel drive vehicle, or more generally on the four wheels of vehicles equipped with an ABS braking system or an ESP directional correction system.

The axis of the front set 2 is connected via a transmission system (not shown) to an internal combustion engine 5, notably comprising an air inlet 6, bringing fresh air through an air filter 9 to cylinders 7 of the engine. The engine 5 is equipped with a liquid cooling circuit 10. A temperature sensor 8 is disposed in the air inlet circuit 6 between the air filter 9 and the inlet of the cylinders 7. A temperature sensor 11 is disposed in the neighborhood of the engine 5 in contact with the liquid of the cooling circuit 10. The wheel speed sensors 12 and 13, and the temperature sensors 8 and 11, are connected via respective connections 16, 17, 14, 15 to an electronic control unit 18. The electronic control unit 18 notably comprises a module 21 for estimating the instantaneous speed of the vehicle, the module 21 being connected to the connections 16 and 17 of the wheel speed sensors. The electronic control unit 18 also comprises a reset module 19 connected via the connections 14 and 15 to the two temperature sensors 8 and 11, and a module 20 for current estimation of the current outside temperature, the module 20 being connected via a connection 16 to the temperature sensor 8 for air admitted into the engine. The module for current estimation of the temperature 20 is furthermore connected to the two other modules, a reset module 19 and a module 21 for estimating the speed of the vehicle. When, after the vehicle has been stopped, the engine 5 is started, the reset module 19 is activated. It then records a value of initial temperature of the air admitted into the engine, which value is transmitted by the sensor 8, and an initial temperature of the coolant liquid, which temperature is transmitted by the sensor 11. Based on these two values, the reset module 19 calculates an initial value of air temperature outside the vehicle which it transmits to the module for current estimation of temperature 20.

Once the vehicle is moving, the estimation module periodically receives an estimated value of instantaneous speed of the vehicle from the module 21, and a measured value of temperature of the air admitted into the engine coming from the sensor 8. The estimation module 20 carries out a mathematical filtering of the value coming to it from the sensor 8, the filtering parameters being adapted as a function of the current value of instantaneous speed of the vehicle, and depending on the initial value of temperature that was transmitted to it by the reset module 19. The value thus filtered can be considered as an estimation of the air temperature outside the vehicle, and can be used, for example, for displaying information intended for the driver, or for estimating temperatures of various dissipative mechanical components, for example one or more temperatures internal to a coupler for transferring a torque 4 between a front wheel set 2 and a rear wheel set 3 of the vehicle.

FIG. 2 shows, over an interval of time AG including driving phases of the vehicle 1 in FIG. 1, one example of curve of actual outside temperature 27, and curves of measured or estimated temperature 25, 26 and 28. The interval of time AG comprises the following driving sequences:

At A, the vehicle 1 starts after being stopped for a long period and drives until time B at a speed below 15 km/hour. Over the interval BC, the speed of the vehicle keeps to values above 15 km/hour. Over the interval of time CD, the vehicle slows down and its speed V falls below 15 km/hour. A time D, the vehicle stops, the engine is switched off and the vehicle remains stopped until time E. At time E, the vehicle starts up again and travels at a speed below 15 km/hour until time F. Between time F and time G, the vehicle re-assumes a cruising speed higher than 15 km/hour.

The curve 27, indicating the temperature outside the vehicle, is given based purely on theory since there is no direct access to it. It is nevertheless shown because it has an influence on the behavior over time of the other temperatures measured. The curves 25 and 26 respectively show the temperature of the coolant liquid delivered by the sensor 11 in FIG. 1, and the temperature of the air admitted into the engine, delivered by the sensor 8 in FIG. 1. At the start up A of the vehicle, the curves 25, 26 and 27 are close to one another, because the coolant liquid, the conduits in which the air admitted into the engine flows, and the whole of the engine compartment have substantially attained thermal equilibrium with the air outside the vehicle.

After the vehicle is started at time A, the temperature indicated by the curve 25 of the coolant liquid increases up to a temperature which can come close to 90°, and remains close to this level until the vehicle is stopped at time D. The interval of time DE during which the vehicle is stopped does not allow this coolant liquid to completely cool down, with the result that, at the time E that the vehicle is restarted, the temperature of the coolant liquid is still relatively high, for example here higher than 75°.

After the vehicle has been started at time A, the temperature of the air admitted into the engine, given by the curve 26, initially increases up to around 50°, because the conduits within which the inlet air flows heat up at the same time as the whole of the engine compartment. When the vehicle is subsequently driven, and with the increase in speed of the vehicle over the interval of time BC, the flow of air circulating under the engine hood limits the heating of the components under the engine hood, which reduces the difference in temperature between the temperature of the curve 26, indicating the temperature of the air admitted into the engine, and the temperature 27 of air outside the vehicle. The difference between the air temperature outside the vehicle and the temperature of the inlet air continues however to oscillate, for example because of the variations in temperature under the engine hood caused by changes in speed of the engine.

Upon the second restarting of the vehicle at time E, the engine compartment is still at a temperature substantially higher than the air temperature outside the vehicle, with the result that the temperature 26 of the air admitted into the engine is, initially, relatively high (higher than 50° C.), before decreasing down to values close to 30°, once a sufficient circulation of air has been established under the engine hood when the vehicle has reached a cruising speed higher than 15 km/h.

The curve 28 shows the estimated temperature of air outside the vehicle, obtained by mathematical filtering of the curve 26 by means of the estimation module 20. At the time the vehicle is started A, an initial value 29 of temperature is supplied to the estimation module 20 by the reset module 19 in FIG. 1. The initial value 29 is here equal to the temperature measured for the air admitted into the engine when the vehicle is started, because the reset module, by comparing the temperature of the coolant liquid and of the air admitted into the engine, concludes that the vehicle has had the time to cool down to ambient temperature.

After the vehicle has been started, as long as the temperature of the recorded curve 26 remains higher than the latest temperature calculated for the curve 28, at the time of each calculation, the estimation module 20 increments the estimated temperature 28, in such a manner that this curve 26 has a maximum slope a. Once the curve 28 has met the curve 26, for example at the points 31, 32 or 33, the curve 28 then follows the curve 26 for as long as the gradient of the curve 26 remains less than the imposed maximum gradient a. The two curves therefore subsequently coincide for as long the curve 26 is decreasing, or the curve 26 is increasing at a lower rate than the imposed maximum gradient.

The maximum gradient imposed on the curve 28 varies as a function of the instantaneous speed V of the vehicle. In the example illustrated in FIG. 2, this gradient takes two separate values, the first value of gradient corresponding to the speeds V below 15 km/hour, in other words to the time intervals AB, CD and EF, and the second value of gradient corresponding to the instantaneous speeds greater than 15 km/hour, in other words, in FIG. 2, to the time intervals BC and FG.

When the vehicle restarts at time E, the reset module 19 delivers a new initial value 30 of air temperature outside the vehicle. The current estimation module 20 uses the initial value 30 in order to restart the filtering of the values of the curve 26 according to the process previously explained. In the case illustrated in FIG. 2, at the time of this second “hot” restarting of the vehicle, the temperature 25 of the coolant liquid and the temperature 26 of the air admitted into the engine are relatively high. The reset module 19 then assigns a maximum arbitrary value to the initial temperature 30.

FIG. 3 provides a simplified illustration of one possible mode of operation of the reset module 19 in the electronic control unit 18 in FIG. 1. In FIG. 3, there are some elements in common with FIG. 1, the same elements then carrying the same references. In a ROM memory 39, the reset module 19 disposes of calculation parameters ΔT, T_{LM} and T_{MAX}. Once the combustion in the cylinders of the engine has commenced, a state counter z is reset to zero in the step 40, and the reset module 19 receives via the connections 14 and 15 a measured value Tₐᵢᵣ(z) representing the temperature of the air admitted into the engine, and a measured value T_{liq}(z) representing the temperature of the coolant liquid in the neighborhood of the engine. In the step 41, these measured values are assigned to initial values Tₐᵢᵣ_{_{—}}ᵢₙᵢ and T_{liq}_{_{—}}ᵢₙᵢ. In the steps 42 and 43, tests are carried out on the values Tₐᵢᵣ_{_{—}}ᵢₙᵢ and T_{liq}_{_{—}}ᵢₙᵢ in order to determine in the steps 44 and 45 which of the two values of Tₐᵢᵣ_{_{—}}ᵢₙᵢ, measured by the sensor 8, or of Tₘₐₓ recorded in the memory 39, will be assigned to the variable T_{filtre}(0) which will be used henceforth by the module 20 as initial value of temperature outside the vehicle. According to the tests 42 and 43, the initial value of temperature of the inlet air Tₐᵢᵣ_{_{—}}ᵢₙᵢ is chosen as initial value T_{filtre}(0) if the two following conditions are simultaneously met:

the difference in temperature between the initial temperature of inlet air Tₐᵢᵣ_{_{—}}ᵢₙᵢ and the initial temperature T_{liq}_{_{—}}ᵢₙᵢ of coolant liquid is lower in absolute value than a value ΔT stored in the ROM memory 39;

the value T_{liq}_{_{—}}ᵢₙᵢ of coolant liquid is less than a maximum value stored in the ROM memory 39.

If one or the other of these conditions is not met, an arbitrary value Tₘₐₓ, also stored in the ROM memory 39, is assigned to the initial value T_{filtre}(0) of estimated outside temperature.

FIG. 4 shows a simplified illustration of one possible mode of operation of the module 20 for current estimation of the temperature outside the vehicle. FIG. 4 re-uses the elements in common from FIG. 1, the same elements being denoted by the same references. In a ROM memory 49, the estimation module 20 disposes of calculation parameters Vₗᵢₘ, Tₘₐₓ, a and A. When the reset module 19 in FIG. 1 has determined an initial value T_{filtre}(0), it transmits it to the estimation module 20 in the step 50. This initial value T_{filtre}(0) is assigned to an intermediate calculation variable T_{c}, at the same time as a state indicator z is forced to zero.

In the step 51, the state indicator z is incremented by one unit, and the estimation module 20 receives, via the connection 14 connecting it to the sensor 8 in FIG. 1, a current value Tₐᵢᵣ(z) representing the temperature of the air admitted into the engine. The module 20 also receives, from the speed estimation module 21, a value V(z) giving the instantaneous speed of the vehicle. The values Tₐᵢᵣ(z), T_{c} and V(z), acquired in the step 52, then undergo tests in the steps 53 and 54, based on which, in a step 57, the value Tₐᵢᵣ(z) for air admitted into the engine is directly assigned to the filtered current value T_{filtre}(z), augmented where necessary by a value of maximum acceptable temperature Tₘₐₓ; or it is decided to apply, in a step 58, a filtering to the slope of the estimated outside temperature, values of maximum slope a or A being previously selected in steps 55 and 56. The step 57 is triggered if, in the test 53, the air temperature measured at the inlet Tₐᵢᵣ(z) is lower than or equal to the temperature T_{c} estimated in the preceding step.

In the opposite case, the test 54 is triggered for selecting a first value “a” of gradient, if the instantaneous speed V(z) of the vehicle is less than or equal to a speed V_{lim,} and for selecting a value of gradient “A” in the opposite case. The values a, A, Vₗᵢₘ, are parameters recorded in the ROM memory 49. In the step 58, the gradient a or the gradient A is used for incrementing the value T_{c} estimated for the preceding state indicator z, in order to obtain a value T_{filtre}(z), corresponding to the current state indicator z.

The value, filtered or as is, of the air temperature measured at the inlet of the engine is then assigned to a current value of estimated outside temperature T_{filtre}(z). In any of the scenarios, the estimated value of temperature T_{filtre} (z) is increased by the value of maximum acceptable temperature Tₘₐₓ, which is a constant stored in the ROM memory 49. The estimated value of temperature T_{filtre}(z) is then assigned to the calculation intermediate variable T_{c}. The process then continues at the step 51 by incrementing the state indicator z. The value T_{filtre} (z) representing the estimated outside temperature can then be transmitted to other calculation modules, for example estimating the temperatures of dissipative components.

In the interests of safety, it could be chosen to systematically increase the value T_{filtre}(z) by adding to it a constant positive increment δ, representing for example a measurement uncertainty associated with sensor 8.

Underestimating the temperature of the mechanical components, which it is sought not to overheat, will thus be avoided. The addition of the increment δ could be carried out before or after having applied the value of maximum threshold Tₘₐₓ to the value of outside temperature T_{filtre} (z). In summary, it could be said that the estimated value of temperature is, on the one hand, augmented in value by the measured temperature of the air admitted into the engine, this augmentation taking place following the test 53 in the step 57, and, on the other hand, that the estimated value of temperature is increased, in terms of slope or derivative, by at least two different values of positive gradient a and A. This increase in slope takes place in the step 58, after having selected the appropriate value of gradient in the steps 55 or 56. In the example illustrated in FIG. 4, two different values of positive gradient a and A are imposed depending on whether the instantaneous speed V of the vehicle is higher or lower than a threshold speed Vₗᵢₘ.

The permitted maximum value of gradient “A” for speeds higher than Vₗᵢₘ, is itself higher than the value of gradient “a” permitted for the lower speeds, because the faster the vehicle is moving, the more it is considered possible that a positive variation in temperature reflects an effective variation in the outside temperature and not a simple temporary heating of the elements present under the engine hood. Variant embodiments may be envisioned where several limiting speeds would be defined, each corresponding to a transition from one maximum gradient to another maximum gradient. Variants may also be envisioned where a minimum negative gradient is imposed on the estimated temperature T_{filtre} Z in such a manner as not to transfer onto this estimated temperature a certain amount of acquisition noise from the values delivered by the temperature sensor 8. By way of example, for the parameters stored in the memory 39 in FIG. 3, the following values could be taken:

Relating to the maximum difference in temperature ΔT between the initial temperature of the engine coolant and the initial temperature of that air admitted into the engine, values in the range between 5° and 20°, or more preferably, between 10° and 15° could be taken.

Relating to the value T_{LM} of maximum temperature of the coolant liquid, above which it is considered that the temperature of the air admitted into the engine can no longer be accepted as ambient air temperature, values in the range between 20° and 50° could be taken depending on the climate of the country where the vehicle is being driven, for example 30° for a country of Western Europe.

Relating to the value Tₘₐₓ of maximum acceptable temperature for the estimated temperature outside the vehicle, values in the range between 40° and 60° for a vehicle being driven in a temperate country could be taken, for example a value of 50°.

Relating to the value δ of increment to be systematically added to the estimated outside temperature, a value will be taken which will depend on the precision of the temperature sensor 8. The value of δ could for example be around 10° C.

Relating to the parameters stored in memory 49 for the current estimation module 20 in FIG. 4, the same value of estimated maximum temperature Tₘₐₓ as for the reset module 19 in FIG. 3 could be taken; the following values could also be chosen for speed threshold and for maximum gradients: the speed threshold must be a speed in the range between 10 and 30 km/hour, for example 15 km/hour; the first value of maximum positive gradient “a” applied when the speed is lower than the speed Vₗᵢₘ can for example be in the range between 0.001° C./second and 0.01° C./second, for example equal to 0.006° C./second; the gradient A corresponding to higher speeds could for example be in the range between 0.005° C./second and 0.05° C./second and be for example equal to 0.017° C./second.

In the case, not mentioned in FIG. 4, where a negative minimum gradient imposed on the estimated outside speed is also chosen, this negative minimum gradient could be chosen in absolute value equal to a multiple in the range between 10 and 100 of the higher of the maximum positive gradients, here the maximum gradient A. For example, in the case where the maximum gradient A is equal to 1° C./minute, the minimum gradient could be taken equal to −1° C./second.

The invention is not limited to the exemplary embodiments described, and can be defined in many variants by including supplementary filtering components in addition to the filtering already described. In the case of a vehicle other than a four wheel drive vehicle or of a vehicle equipped with ABS or ESP, the instantaneous speed of the vehicle may simply be deduced from the rotation speed of a single rev counter placed on one of the wheels or on one of the axle sets. It is possible, each time that a measurement or an evaluation is made and transmitted, to simultaneously transmit with the measured or estimated value a Boolean indicator of validity which corresponds to whether the estimated or measured value presents a sufficient level of credibility or not. The estimated or measured value is then processed in the following step in a different manner depending on its level of credibility. The various threshold values and gradient values can take values other than those stated here or can be adapted for the same vehicle according to the season.

The evaluation system according to the invention uses a minimum number of input data values, these input data values being available by default on the majority of existing vehicles. The reduced number of sensors involved, and the simplicity of the algorithm, guarantee a very robust system. The choice of an initial temperature which is purposely overestimated whenever it is judged that the engine compartment has not had the time to cool down to the ambient temperature, also leads to an overestimate of the temperature of the dissipative mechanical components, at least during the phase immediately following the starting of the engine. This choice leads to modes of operation with limited dissipation of energy being imposed on these mechanical components, in such a manner as to avoid them being overheated. The system for estimating the temperature outside the vehicle according to the invention is therefore robust, cost-effective, and a safety feature.

1-11. (canceled)

12. A method for determining an estimated value of air temperature outside a vehicle propelled by an internal combustion engine, the method comprising:
assigning an initial estimated value to an estimated temperature;
then measuring temperature of air admitted into the engine and evaluating a speed of the vehicle; and
carrying out a mathematical filtering of the measured temperature of air admitted into the engine, the filtering imposing on the estimated temperature a maximum gradient taking at least two different positive values over time, one of these maximum positive values of gradient being selected as a function of instantaneous speed of the vehicle.

13. The method for determining the outside air temperature as claimed in claim 12, in which an initial temperature of air admitted into the engine and an initial temperature of a coolant liquid having spent time in a cooling circuit of the engine are measured, and an initial estimated value of temperature is deduced from these two values.

14. The method for determining the outside air temperature as claimed in claim 12, in which a first maximum temperature threshold is imposed on the estimated air temperature and on its initial value.

15. The method for determining the outside air temperature as claimed in claim 13, in which the value of the first maximum temperature threshold is imposed on the initial estimated value of temperature, if the difference between the initial temperature of air admitted into the engine and the initial temperature of the coolant liquid is higher than a second difference threshold.

16. The method for determining the outside air temperature as claimed in claim 15, in which the value of the first maximum temperature threshold is imposed on the initial estimated value, if the initial temperature of incoming air is higher than a third threshold, or if the initial temperature of the coolant liquid is higher than a fourth threshold.

17. The method for determining the outside air temperature as claimed in claim 15, in which the initial temperature of the air admitted into the engine is taken as the initial estimated value, or the initial temperature of the coolant liquid, when the difference between these two temperatures is less than the second difference threshold.

18. The method for determining the outside air temperature as claimed in claim 12, in which the estimated temperature is equal to the temperature of the air admitted into the engine over periods of time where the temperature of the air admitted into the engine is decreasing.

19. The method for determining the outside air temperature as claimed in claim 12, in which at least two different maximum positive gradients are imposed on the estimated temperature when the estimated temperature is increasing, and at least one minimum negative gradient when the estimated temperature is decreasing, the negative gradient being in absolute value greater than at least ten times each of the two positive gradients.

20. The method for determining the outside air temperature as claimed in claim 12, in which the filtering imposes a first maximum positive gradient in a range between 0.001° C./s and 0.01° C./s, and a second maximum positive gradient which is a multiple of the first positive gradient by a number in a range between 2 and 5.

21. A method for estimating at least one temperature internal to a coupler for transferring a torque between two sets of wheels of a vehicle, using a method for estimating the air temperature outside the vehicle as claimed in claim 12.

22. A system for determining an estimated value of air temperature outside a vehicle propelled by an internal combustion engine, comprising:
a sensor of temperature of air admitted into the engine;
a sensor for temperature of a coolant liquid of the engine;
a device for evaluation of instantaneous speed of the vehicle;
a reset module configured to determine an initial temperature based on an initial temperature of the air admitted into the engine and on an initial temperature of the coolant liquid; and
an estimation module configured to mathematically filter the temperature of the air admitted into the engine such as to impose on the filtered value a maximum gradient taking at least two different positive values over time, one or the other of these values of maximum positive gradient being selected as a function of instantaneous speed of the vehicle.
